(19) United States
(12) Patent Application Publication
(10) Pub. No.: US 2011/0161859 A1
(43) Pub. Date: Jun. 30, 2011

(54) ELECTRONIC DEVICE AND METHOD FOR PINYIN INPUT

(75) Inventor: TAO ZHANG, Shenzhen City (CN)

(73) Assignees: SHENZHEN FUTAIHONG PRECISION INDUSTRY CO., LTD., ShenZhen City (CN); Chi Mei Communication Systems, Inc., Tu-Cheng City (TW)

(21) Appl. No.: 12/749,484

(22) Filed: Mar. 29, 2010

(30) Foreign Application Priority Data
Dec. 30, 2009 (CN) 200910312826.0

(51) Int. Cl. G06F 3/048; G06F 3/041

(52) U.S. Cl. 715/773; 715/816; 345/173

(57) ABSTRACT

An electronic device and a method for pinyin input include setting an initial virtual keyboard and a virtual keyboard as a word delimiter and determining whether received input is a word delimiter or not. The electronic device and the method further include retrieving the Chinese character database and confirming match letters after the input letters, and displaying virtual keystrokes on a display of the electronic device corresponding to the match letters.

### BACKGROUND

1. Field of the Invention

Embodiments of the present disclosure are related to data input, and in particular, to an electronic device and method for pinyin input in the electronic device.

2. Description of Related Art

Chinese characters may be input into a computing system using a pinyin input system. At present, when pinyin is used to input a character, a display of an electronic device may provide each letter for a selection to be made.

However, when many letters are displayed, the letters are displayed smaller, making it difficult to locate the one desired. Using a stylus to input the characters using pinyin may further trouble the user.

What is needed, therefore, is an improved electronic device and method for pinyin input in the electronic device addressing the described limitations.

### BRIEF DESCRIPTION OF THE DRAWINGS

FIG. 1 is a block diagram of an embodiment of an electronic device including a pinyin input system.

FIG. 2 is a schematic diagram of one embodiment of letter input via the electronic device of FIG. 1.

FIG. 3 is a flowchart of one embodiment of a method for pinyin input used in the electronic device of FIG. 1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

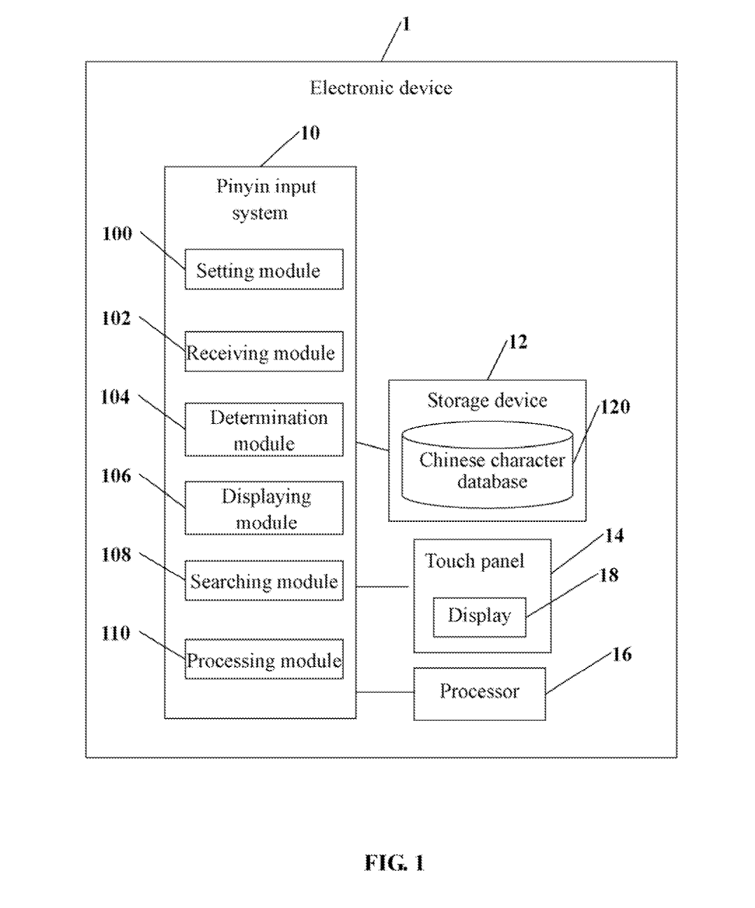

FIG. 1 is a block diagram of one embodiment of an electronic device 1 including a pinyin input system 10. In one embodiment, the electronic device 1 and the pinyin input system 10 may be used to search a preset database for predicted characters according to received letters, and display virtual keystrokes corresponding to the predicted characters. The electronic device 1 further includes a storage device 12, a touch panel 14, and a processor 16. The storage device 12 may be the memory of the electronic device 1 and also may be an external storage card, for example, such as a smart media (SM) card, secure digital (SD) card or other. The storage device 12 may store various kinds of data, such as a Chinese character database 120, for example. The touch panel 14 includes a display 18. The processor 16 executes one or more computerized operations of the electronic device 1 and other applications, to provide the functions of the electronic device 1. Depending on the embodiment, the electronic device 1 may be a mobile phone, a notebook computer, or a personal digital assistant, or any other electronic device.

In the embodiment of the present disclosure, the pinyin input system 10 comprises a setting module 100, a receiving module 102, a determination module 104, a displaying module 106, a searching module 108, and a processing module 110. The modules 100, 102, 104, 106, 108, and 110 may comprise one or more computerized codes to be executed by the processor 16 to perform one or more operations of the electronic device 1. Details of these operations are provided as follows.

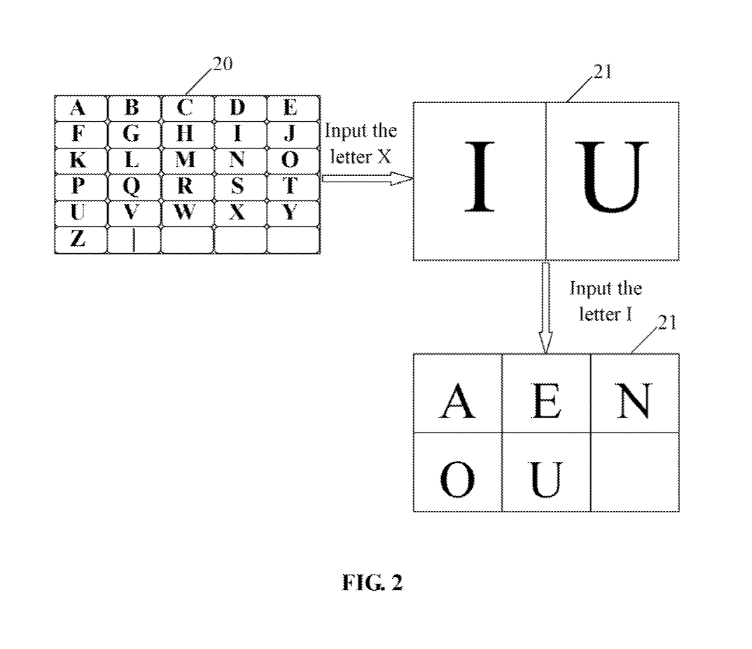

The setting module 100 sets an initial virtual keyboard 20. The initial virtual keyboard 20 may be displayed on the display 18 of the touch panel 14. In one embodiment, as shown in FIG. 2, the initial virtual keyboard 20 displays all letters of the English alphabet (defined as “virtual keystrokes”). These letters may be selected by depression of a finger or a stylus on the touch panel 14. In one embodiment, the distribution and the arrangement of the virtual keystrokes on the virtual keyboard may be configured according to actual requirements or input habits.

The setting module 100 further sets a virtual keystroke as a word delimiter input. The word delimiter means that a subsequent input letter would be a beginning of a new Chinese pinyin string rather than the current or a previous pinyin input string, and may be activated upon completion of current pinyin string input. In one embodiment, as shown in FIG. 2, the virtual button “|” acts as the word delimiter input. In another embodiment, any virtual keystroke can be set as the word delimiter according to actual requirements.

The receiving module 102 receives one or more input letters in response to user input when the electronic device 1 is in a pinyin input mode and the initial virtual keyboard 20 is shown on the display 18. In one embodiment, the received input may be a letter or a string including a plurality of letters.

The determination module 104 determines whether the receiving module 102 receives a word delimiter input.

The displaying module 106 displays the initial virtual keyboard on the display 18 when a word delimiter input is received.

If the receiving module 102 does not receive a word delimiter input, the searching module 108 searches the Chinese character database 120 for Chinese pinyin strings that begin with the input letters so as to retrieve the Chinese pinyin strings that begin with the input letters.

If the searching module 104 does not retrieve any Chinese pinyin strings that begin with the input letters, the processing module 110 generates a notification on the display 18 that an unmatchable Chinese pinyin string has been input. In one embodiment, the notification can comprise a pop-up message such as “Unable to search any corresponding Chinese character pinyin strings” displaying on the display 18. Further input may be chosen, or the input modified.

If the searching module 104 retrieves Chinese pinyin strings that begin with the input letters, the processing module 110 further confirms one or more next letters that after the input letters from the retrieved Chinese character pinyin strings as match letters. In one embodiment, according to the pinyin combinations of the Chinese characters, when a letter “X” is input, the match letters after the “X” are merely “I” and “U”. Then the letters “I” and “U” would set to be as match letters that begins with the letter “X”. A detailed example is provided below.

The displaying module 108 displays virtual keystrokes corresponding to the match letters on the display 18 of the touch panel 14, allowing easy location and selection of a target input letter from the displayed virtual keystrokes.

The determination module 104 further determines whether the input has been completed. In one embodiment, the determination module 104 may confirm that the input has been completed if a current edited message has been transmitted, and/or pinyin input mode has been shut down. Otherwise, if the message has not been transmitted, and/or the pinyin input mode has not been shut down, the determination module 104 determines that the input has not been completed.

For example, referring to FIG. 2, each virtual keystroke on the set initial virtual keyboard 20 merely represents one letter. If the received letter is “X,” the searching module 108 searches the Chinese character database 120 and retrieves Chinese character pinyin strings that begin with “X”, such as “xi”, “xia”, “xiao”, “xian”, “xiang”, “xie”, “xin”, “xing”, “xiong”, “xiu”, “xu”, “xuan”, and “xue”, for example. The processing module 110 confirms the match letters after the received letter “X” as “i,” and “u,” and then the displaying module 106 displays the virtual keystrokes “i,” “u” on the display 18 of the touch panel 14. then the initial virtual keyboard 20 changes the displayed virtual keyboard as a virtual keyboard 21 (As shown in FIG. 2), so as to prompt the subsequent letter. If “i,” is selected, the received letters are “XI”, the searching module 108 searches the Chinese character database 120 and retrieves Chinese character pinyin strings that begin with “XI”, such as “xia”, “xiao”, “xian”, “xiang”, “xie”, “xin”, “xing”, “xiong”, “xiu”, for example. The processing module 110 confirms the match letters after the received letter “XI” as “a,” “e,” “n,” “o,” and “u,” and then the displaying module 106 displays the virtual keystrokes as “a,” “e,” “n,” “o,” and “u” on the display 18 of the touch panel 14. Then the virtual keyboard 22 (As shown in FIG. 2) is shown on the display 18. In one embodiment, the way of displaying on the display 18 would be various according to user preference.

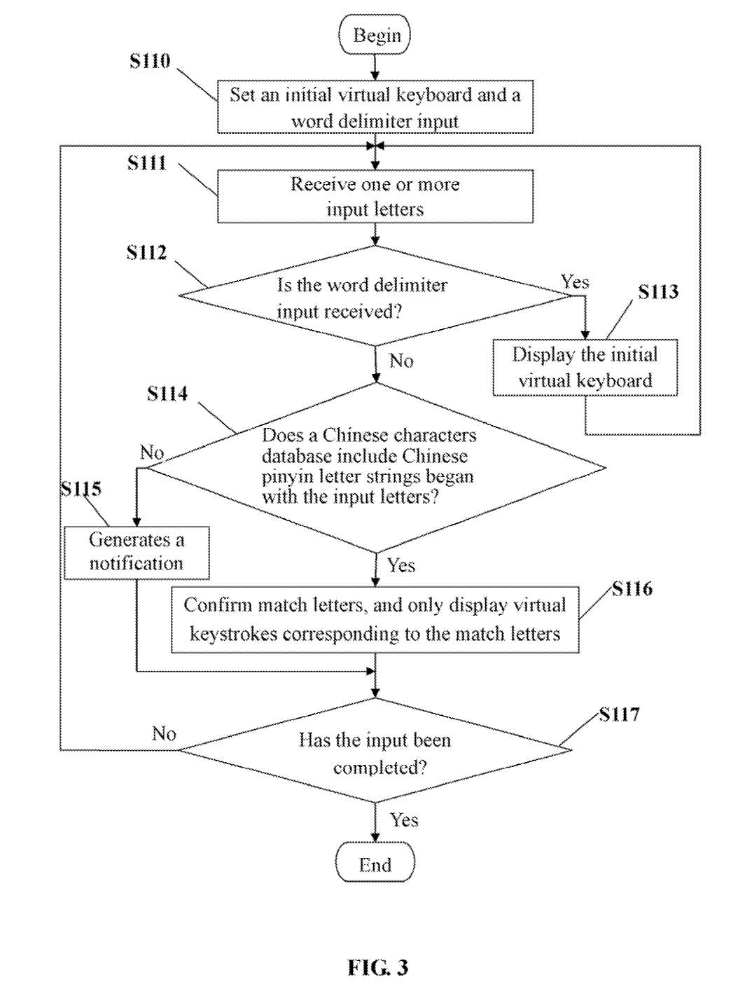

FIG. 3 is a flowchart of one embodiment of a method for pinyin input used in an electronic device, such as, for example, that of FIG. 1. Depending on the embodiment, additional blocks may be added, others removed, and the ordering of the blocks may be changed.

In block S110, the setting module 100 sets an initial virtual keyboard 20 and sets a virtual keystroke as a word delimiter input. The initial virtual keyboard 20 may be displayed on a display 18 of the touch panel 14.

In block S111, when the electronic device 1 is in a pinyin input mode and the initial virtual keyboard 20 is shown on the display 18, the receiving module 102 receives one or more input letters or strings in response to user input.

In block S112, the determination module 104 determines whether the receiving module 102 receives a word delimiter input.

If a word delimiter input is received, in block S113, the displaying module 106 displays the initial virtual keyboard 20.

If the receiving module 102 does not receive a word delimiter input, in block S114, the searching module 108 searches the Chinese character database 120, and determines whether Chinese character database 120 includes Chinese pinyin strings that begin with the input letters so as to retrieve the Chinese pinyin strings that begin with the input letters.

If the searching module 104 does not retrieve any Chinese pinyin strings that begin with the input letters, in block S115, the processing module 110 generates a notification on the display 18 to prompt that an unmatchable Chinese pinyin string has been input. As mentioned, the notification can comprise a pop-up message such as “Unable to search any corresponding Chinese pinyin strings” displaying on the display 18. Then, input may continue, or the input letters may be modified. Then the procedure turns to block S117.

If the searching module 104 retrieves the Chinese pinyin strings that begin with the input letters in the Chinese character database 120, in block S116, the processing module 110 further confirms one or more next letters that after the input letters from the retrieved Chinese character pinyin string as match letters, and the displaying module 108 only displays virtual keystrokes corresponding to the match letters on the display 18 of the touch panel 14.

In block S117, the determination module 104 determines whether the input has been completed. As mentioned above, if a current edited message has been transmitted, and/or the pinyin input mode has shut down, the determination module 104 determines that the input has been completed. Otherwise, block 5111 is repeated and, the receiving module 102 continues to receive input letters or strings.

It should be emphasized that the described inventive embodiments are merely examples of implementations, and set forth for a clear understanding of the principles of the present disclosure. Many variations and modifications may be made to the above-described inventive embodiments without departing substantially from the spirit and principles of the present disclosure. All such modifications and variations are intended to be comprised herein within the scope of this disclosure and the above-described inventive embodiments, and the present disclosure is protected by the following claims.

What is claimed is:

1. An electronic device, comprising:
a storage device operable to store a Chinese character database;
a touch panel;
at least one processor; and
one or more programs stored in the storage device and being executable by the at least one processor, the one or more programs comprising:
a setting module operable to set an initial virtual keyboard, and set a virtual keystroke as a word delimiter input;
a receiving module operable to receive one or more input letters when the electronic device is in a pinyin input mode and the initial virtual keyboard is shown on a display of the touch panel;
a determination module operable to determine whether the word delimiter input is received;
a searching module operable to search the Chinese character database for Chinese pinyin strings that begin with the input letters, and retrieve all Chinese pinyin strings from the Chinese character database that begin with the input letters;
a processing module operable to confirm one or more next letters after the input letters in the retrieved Chinese character pinyin strings as match letters; and
a displaying module operable to display virtual keystrokes corresponding to the match letters on the display of the touch panel.

2. The electronic device as claimed in claim 1, wherein the displaying module is further operable to display the initial virtual keyboard on the display when the word delimiter input is received.

3. The electronic device as claimed in claim 1, wherein the determination module is further operable to determine whether the input has been completed.

4. The electronic device as claimed in claim 3, wherein the determination module determines whether the input has been completed by determining if a current edited message has been transmitted, or the pinyin input mode has shut down.

5. The electronic device as claimed in claim 1, wherein the processing module is further operable to generate a notification on the display that an unmatchable Chinese pinyin string has been input.

6. A computer-implemented method for pinyin input used in an electronic device, the electronic device comprising a storage device storing a Chinese character database, the method comprising:
setting an initial virtual keyboard, and setting a virtual keystroke as a word delimiter input;
receiving one or more input letters when the electronic device is in a pinyin input mode and the initial virtual keyboard displays on a display of the touch panel;
determining whether a word delimiter input is received;
retrieving the Chinese character database, and searching the Chinese character database for one or more Chinese pinyin strings that begin with the input letters so as to retrieve the Chinese pinyin strings when the word delimiter input is not received;
confirming one or more next letters after the input letters from the retrieved Chinese character pinyin strings as match letters; and
displaying only virtual keystrokes corresponding to the match letters on the display.

7. The method as claimed in claim 6, further comprising displaying the initial virtual keyboard on the display when the word delimiter input is received.

8. The method as claimed in claim 6, further comprising:
generating a notification on the display that an unmatchable Chinese pinyin string has been input when the Chinese character database does not include any Chinese pinyin strings that begin with the input letters.

9. The method as claimed in claim 6, further comprising:
determining whether the input has been completed; and
if the input has been completed, ending the procedure; or
if the input has not been completed, returning to the receiving step.

10. The method as claimed in claim 9, wherein the method for determining whether the input has been completed by determining if a current edited message has been transmitted, or the pinyin input mode has shut down.

11. A storage medium storing a set of instructions, the set of instructions capable of being executed by a processor to perform a method for pinyin input used in an electronic device, the electronic device comprising a storage device storing a Chinese character database, the method comprising:
setting an initial virtual keyboard, and setting a virtual keystroke as a word delimiter input;
receiving one or more input letters when the electronic device is in a pinyin input mode and the initial virtual keyboard displays on a display of the touch panel;
determining whether a word delimiter input is received;
retrieving the Chinese character database, and determining whether the Chinese character database includes one or more Chinese pinyin strings that begin with the input letters so as to retrieve the Chinese pinyin strings when the word delimiter input is not received;
confirming one or more next letters after the input letters from the retrieved Chinese character pinyin strings as match letters; and
displaying only virtual keystrokes corresponding to the match letters on the display.

12. The storage medium as claimed in claim 11, wherein the method further comprises displaying the initial virtual keyboard when the word delimiter input is received.

13. The storage medium as claimed in claim 11, wherein the method further comprises:
generating a notification on the display that an unmatchable Chinese pinyin string has been input when the Chinese character database does not include any Chinese pinyin strings that begin with the input letters.

14. The storage medium as claimed in claim 11, wherein the method further comprises:
determining whether the input has been completed; and
if the input has been completed, ending the procedure; or
if the input has not been completed, returning to the receiving step.

15. The storage medium as claimed in claim 14, wherein the method for determining whether the input has been completed by determining if a current edited message has been transmitted, or the pinyin input mode has shut down.
